(19) United States
(12) Patent Application Publication
(10) Pub. No.: US 2005/0191922 A1
(43) Pub. Date: Sep. 1, 2005

(54) Fiber mat having improved tensile strength and process for making same

(75) Inventors: Linlin Xing, Wayne, NJ (US); Brian Duffy, Wayne, NJ (US); William Bittle, York, SC (US); Betty Roberts, Chester, SC (US); Chuck Ford, Chester, SC (US)

Correspondence Address: William J. Davis, Esq.;GAF MATERIALS CORPORATION, Legal Department, Building No. 10, 1361 Alps Road, Wayne, NJ, 07470, US

(73) Assignee: BUILDING MATERIALS INVESTMENT CORPORATION

(21) Appl. No.: 10/789,215

(22) Filed: Feb. 27, 2004

(51) Int. Cl. B32B 17/02; B32B 27/38

(52) U.S. Cl. 442/175; 442/180; 442/176; 162/135; 162/156; 162/166; 162/171

(57) ABSTRACT

A fiber mat of improved tensile strength and a process of making same is disclosed. The fiber mat comprises: fibers; a resinous fiber binder; and a urethane binder modifier.

### FIELD OF THE INVENTION

The present invention relates generally to a fiber mat and process of making same. In particular, the present invention relates to a glass fiber mat comprising fibers, a binder, and a binder modifier. Embodiments of the present invention may have desired characteristics, such as, for example, improved tensile strength, and may be suitable for use in building materials.

### BACKGROUND OF THE INVENTION

High strength fiber mats have become increasingly popular in the building materials industry. Most commonly used in roofing shingles, fiber mats have numerous other material applications, including use in roofing, siding and floor underlayment; insulation facers; floor and ceiling tile; and vehicle parts.

Various fiber mats and methods of making same have been described. For example, U.S. Pat. No. 4,135,029 describes a glass fiber mat made by a wet-laid process. Glass fiber mats made by the wet-laid process are formed from glass fibers held together by a binder material.

Typically, in wet process glass fiber mats, the binder is applied in a liquid form and dispersed onto the glass fibers by a curtain type applicator. Conventional wet processes strive to produce a uniform coating of binder on the glass fibers. After the binder and glass fibers have been dried and cured, the glass fiber mat is then cut as desired.

A major problem in the manufacture and use of some known fiber mats is inadequate tensile strength. Inadequate tensile strength can cause interruption in roofing manufacture, and may reduce the ability of the finished roofing product to resist stresses during service on the roof. Because building materials, generally, and roofing shingles, in particular, are often subjected to a variety of weather conditions, the fiber mats must also maintain their strength characteristics under a wide range of conditions.

For example, the tensile strength of a shingle at low temperature has significant impact on the performance of the shingle in cold weather. The tensile strength at these temperatures may depend on the adhesion of the fibers to the fiber binder system, the mechanical properties of the binder system, and the interaction of the fiber mats with asphalt.

The fiber mats in accordance with some embodiments of the present invention may be particularly suitable for use as a component of building materials. The fiber mat of various embodiments of the present invention may provide a material having improved tensile strength under a variety of conditions, including low temperatures. In addition, the process of making fiber mats in accordance with some embodiments of the present invention may provide a fiber mat having an improved tensile strength. Additional advantages of embodiments of the invention are set forth, in part, in the description which follows and, in part, will be apparent to one of ordinary skill in the art from the description and/or from the practice of the invention.

### SUMMARY OF THE INVENTION

Responsive to the foregoing challenges, Applicant has developed an innovative fiber mat for use in a building material component. In one embodiment, the fiber mat comprises: a plurality of fibers; a resinous fiber binder, the fibers fixedly distributed in the binder; and a urethane modifier comprising from about 0.1 wt. % to about 50 wt. %, based on the weight of the binder.

Applicant has further developed an innovative fibrous mat roofing shingle. In one embodiment, the fibrous mat roofing shingle comprises: a plurality of glass fibers; and a fixative composition comprising a fiber binder and between about 0.1 wt. % and about 50 wt. %, based on the weight of the binder, of a polyurethane modifier, wherein the fibers are fixedly distributed in the fixative composition.

Applicant has further developed an innovative process for making a fiber mat. In one embodiment, the process comprises the steps of: forming an aqueous fiber slurry; removing water from the fiber slurry to form a wet fiber mat; saturating the wet fiber mat with an aqueous solution of a fiber binder and a polyurethane modifier; and drying and curing the wet fiber mat to form a fiber mat product.

It is to be understood that both the foregoing general description and the following detailed description are exemplary and explanatory only, and are not restrictive of the invention as claimed.

### DETAILED DESCRIPTION OF THE INVENTION

The fiber mat of the present invention comprises a plurality of fibers fixedly distributed in a fixative composition. The fixative composition comprises between about 0.05 wt. % and about 45 wt. % fiber binder, based on the fiber mat product weight, and between about 0.1 wt. % and about 50 wt. % urethane modifier, based on the binderweight.

The urethane modifier may comprise a polyurethane modifier. The polyurethane modifier may comprise, but is not limited to, an aliphatic polyurethane, an aromatic polyurethane, a hybrid polyurethane, and/or a mixture thereof.

In one embodiment of the present invention, the polyurethane modifier may be a polyurethane derivative. The polyurethane modifier may be derived, for example, from an aromatic isocyanate, an aliphatic isocyanate, or a precursor having acrylic functionality. Representative examples of aromatic polyurethanes include those derived from toluene diisocyanate or bis(4-isocyanatophenyl) methane. Examples of polyurethanes generally classified as aliphatic types include those derived from 1,6-hexamethylene diisocyanate, isophorone diisocyanate, bis(4-isocyanatocyclohexyl)methane; aromatic types include those derived from tetramethyl-m-xylidene diisocyanate and isopropenyldimethylbenzyl isocyanate. Polyurethanes derived from polyester based diol or polyol and aromatic isocyanate are generally referred to as polyester based aromatic polyurethanes whereas those derived from a polyether based diol or polyol and an aliphatic isocyanate are referred to as polyether based aliphatic polyurethanes.

As will be apparent to one of ordinary skill in the art, the polyurethane modifier may be commercially available. Sancure® 898, 20023, 2725 and 2720 are examples of aliphatic polyurethanes, supplied by Noveon. Hauthane L-2020 is an example of an aromatic polyurethane, supplied by Hauthaway. Other commercial or non-commercially available polyurethane modifiers are considered well within the scope and spirit of the present invention.

In one embodiment of the present invention, the urethane modifier has a Brookfield viscosity in the range of from about 100 cps to about 300 cps, and a specific density in the range from about 1.02 to about 1.06. Other ranges of the viscosity and specific density of the urethane modifier are considered within the scope and spirit of the present invention.

In one embodiment of the present invention, maleic acid may be employed with the urethane modifier and may hasten curing. The maleic acid may comprise a concentration of up to about 15 wt. % maleic acid with respect to the urethane modifier.

In one embodiment of the present invention, the fiber binder comprises a formaldehyde type resin. The fiber binder may include, but is not limited to, a urea/formaldehyde resin, a phenol/formaldehyde resin, a melamine/formaldehyde resin, and/or a mixture thereof. It is contemplated, however, that other binders, such as, for example, ethylene vinyl acetate, and other known resins adapted for binding mat fibers may be used without departing from the scope and spirit of the present invention.

In one embodiment of the present invention, the urea-formaldehyde resin is a commercially available material, such as, for example, GP2997 supplied by Georgia Pacific Resins, Inc.; Dynea 246 from Dynea Co.; and Borden FG 486D from Borden Chemical Inc. Other commercial formaldehyde resins, such as, for example, S-3701-C supplied by Pacific Resins and Chemicals, Inc.; and PR-913-23, supplied by Borden Chemical, Inc. As will be apparent to those of ordinary skill in the art, other commercially or non-commercially available binders may be used without departing from the scope and spirit of the present invention.

In one embodiment of the present invention, the resinous fiber binder may contain methylol groups which, upon curing, form methylene or ether linkages. These methylols may include, for example, N,N′-dimethylol; dihydroxymethylolethylene; N,N′-bis(methoxymethyl), N,N′-dimethylol-propylene; 5,5-dimethyl-N,N′-dimethylolpropylene; N,N′-dimethylolethylene; N,N′-dimethylolethylene and the like.

In one embodiment, the weight ratio of resinous fiber binder to modifier is in the range of from about 200:1 to about 4:1. In one embodiment of the present invention, the weight ratio is more particularly from about 99:1 to about 9:1.

The fiber binder and the binder modifier are adapted to be compatible. The components may be intimately admixed in an aqueous medium to form a stable emulsion which does not become overly gummy, or gel, potentially even after prolonged storage, e.g. for periods of a year or longer. This may be advantageous in practical commercial use of the composition.

In one embodiment of the present invention, the fibers comprise glass fibers. The glass fibers may comprise individual fiber filaments having an average length in the range of, but not limited to, from about 14 inch to about 3 inches, and an average diameter in the range of, but not limited to, from about 1 to about 50 microns (p). It is contemplated, however, that the glass fibers may be in another form, such as, for example, a continuous strand or strands. In an alternative embodiment of the present invention, the fibers may comprise other fibers, including, but not limited to, wood, polyethylene, polyester, nylon, polyacrylonitrile, and/or a mixture of glass and one or more other fibers. In one embodiment, the fiber mat may further comprise a small amount of filler, e.g. less than about 0.5%, based on the fiber weight. A fiber mixture may be optional for construction material application, such as, for example, roofing and siding, because excessive amounts of filler may reduce porosity and vapor ventability of the fiber mat.

In the finished cured mat product, the fiber content may be in the range of from about 55 wt. % to about 98 wt. %. In one embodiment of the present invention, the fiber content is more particularly in the range of from about 70 wt. % and about 85 wt. %.

The fiber mat in accordance with one embodiment of the present invention may further comprise a fiber dispersing agent for dispersing the plurality of fibers in the fixative composition. The fiber dispersing agent may comprise, for example, tertiary amine oxides (e.g. N-hexadecyl-N,N-dimethyl amine oxide), bis(2-hydroxyethyl) tallow amine oxide, dimethyl hydrogenated tallow amine oxide, dimethylstearyl amine oxide and the like, and/or mixtures thereof. As will be apparent to those of ordinary skill in the art, other known dispersing agents may be used without departing from the scope and spirit of the present invention. The dispersing agent may comprise a concentration in the range of from about 10 ppm to about 8,000 ppm, based on the amount of fiber. The dispersing agent may comprise a concentration in the range of from about 200 ppm to about 1,000 ppm, based on the amount of fiber.

In one embodiment, the fiber mat may further comprise one or more viscosity modifiers. The viscosity modifier may be adapted to increase the viscosity of the binder and/or the fixative composition such that the settling time of the fibers is reduced and the fibers may be adequately dispersed. The viscosity modifier may include, but is not limited to, hydroxyl ethyl cellulose (HEC), polyacrylamide (PAA), and the like. As will be apparent to those of ordinary skill in the art, other viscosity modifiers may be used without departing from the scope and spirit of the present invention.

The fiber fixative composition employed herein may be prepared by blending the selected binder and the polyurethane modifier in water, under agitation until a uniform mixture is obtained. The resulting aqueous mixture may then used to saturate the wet mat of dispersed fibers, after which excess mixture may be removed before drying and curing at an elevated temperature. Alternatively, an aqueous mixture of the binder alone may be prepared and applied to the wet mat of dispersed fibers, in which case the polyurethane may be separately and subsequently applied by spraying, dipping or other means. In still another alternative embodiment, all or a portion of the polyurethane modifier may be applied over the mat after initiation of the drying and/or curing process.

The process of making a fiber mat in accordance with one embodiment of the present invention will now be described. The process will be described with particular reference to a wet-laid process. It is contemplated, however, that other processes known in the art, such as, for example, a dry-laid process, may be used without departing from the scope and spirit of the present invention. Furthermore, the process is described using chopped bundles of glass fibers. As discussed above, however, other types of fiber content are considered well within the scope of the present invention.

The process of forming glass fiber mats according to one embodiment of the present invention comprises adding chopped bundles of glass fibers of suitable length and diameter to a water/dispersant agent medium to form an aqueous fiber slurry. A viscosity modifier or other process aid may also be added to the water/dispersant agent medium. From about 0.05 to about 0.5 wt. % viscosity modifier in white water may be suitably added to the dispersant to form the slurry.

The glass fibers may be sized or unsized, and may be wet or dry, as long as they are capable of being suitably dispersed in the water/dispersant agent medium. The fiber slurry, containing from about 0.03 wt. % to about 8 wt. % solids, is then agitated to form a workable dispersion at a suitable and uniform consistency. The fiber slurry may be additionally diluted with water to a lower fiber concentration to between about 0.02 wt. % and about 0.08 wt. %. In one embodiment, the fiber concentration may be more particularly diluted to about 0.04 wt. % fiber. The fiber slurry is then passed to a mat-forming machine such as a wire screen or fabric for drainage of excess water. The excess water may be removed with the assistance of vacuum.

The fibers of the slurry are deposited on the wire screen and drained to form a wet fiber mat. The wet mat may then be saturated by soaking in an aqueous solution of binder or binder/modifier fixative composition. The aqueous solution may comprise, for example, from about 10 wt. % to about 40 wt. % solid. The wet mat may be soaked for a period of time sufficient to provide the desired fixative for the fibers. Excess aqueous binder or binder/modifier composition is then removed, preferably under vacuum.

After treatment with binder or binder/modifier composition, if desired, the mat is then dried and the fixative composition may be cured in an oven at an elevated temperature. A temperature in the range of about 160° C. to about 400° C., for at least about 2 seconds, may be used for curing. In one embodiment, a cure temperature in the range of about 225° C. to about 350° C. may be used. It is contemplated that in an alternative embodiment of the present invention, catalytic curing may be provided with an acid catalyst, such as, for example, ammonium chloride, p-toluene sulfonic acid, or any other suitable catalyst. As discussed above, any amount of modifier not included with the binder solution may be applied to the drained fiber slurry, the drained mat containing binder, and/or the cured product. The modifier may be applied as a polyurethane spray and/or as a bath as an aqueous solution of the polyurethane.

The combination of the polyurethane modifier and binder used in various embodiments of the present invention may provide several advantages over current binder compositions. For example, the tensile strength of the mat may be increased. In addition, the tensile strength of the mat may be increased at lower temperatures to minimize cracking and failure. Other advantages will be apparent to one of ordinary skill in the art from the above detailed description and/or from the practice of the invention.

Having generally described various embodiments of the present invention, reference is now made to the following examples which illustrate embodiments of the present invention and comparisons to a control sample. The following examples serve to illustrate, but are not to be construed as limiting to, the scope of the invention as set forth in the appended claims.

### EXAMPLES 1-9

### Preparation of the Glass Mat

Part A. In a 20 liter vessel at room temperature, under constant agitation, 5.16 g of chopped bundles of glass fibers, having an average 20-40 mm length and 12-20 micron diameter, were dispersed in 12 liters of water containing 800 ppm of N-hexadecyl-N,N-dimethylamine oxide to produce a uniform aqueous slurry of 0.04 wt. % fibers. The fiber slurry was then passed onto a wire mesh support with dewatering fabric, and vacuum was applied to remove excess water and to obtain a wet mat containing about 60% fibers.

Part B. Eight aqueous samples of 24 wt. % solids containing urea/formaldehyde resin binder (UF) and thermoplastic aliphatic polyurethane elastomer (PU) modifier in varying proportions as indicated in the following table were separately prepared and applied to individual samples of wet glass mats prepared by the procedure in Part A. The individual wet mats were soaked in the binder/modifier solutions under ambient conditions after which excess solution was removed under vacuum to provide binder/modifier wet mats containing 38 wt. % glass fibers, 12 wt. % binder/modifier and 50 wt. % water.

Part C. For comparison purposes, a ninth sample was prepared as described in Parts A and B except that the UF binder was used alone without any PU modification.

Part D. All samples (1-9) were dried and cured for 13 seconds at 300° C. to obtain dry glass mats weighing about 92 g/m².

Part E. Each of the above samples 1-9 were passed to a two-roller coating machine where a 30 mil layer of 32 wt. % asphalt and 68 wt. % limestone filler at 420° F. was applied to each side of the mats. After cooling, the filled asphalt coated mats were cut into 1×8 inch shingle specimens and their tensile strengths tested on an Instron® Tensile Machine at a temperature of below 0° F. The results of these tests are recorded in the following Table 1:

TABLE 1
Binder Compositions and Lab Shingle Testing Results

| | | | | Shingle | Tensile |
|---|---|---|---|---|---|
| Sam- | | | | Tensile | Strength |
| ple | | | UF:PU | Strength | Improvement |
| No. | Binder | Modifier | (w/w) | (psi) | (% vs. control) |
| 1 | GP2997 | Sancure 898 | 99/1 | 1055 | +12% |
| 2 | GP2997 | Sancure 898 | 95/5 | 1110 | +17% |
| 3 | GP2997 | Sancure 20023 | 99/1 | 1231 | +30% |
| 4 | GP2997 | Sancure 2725 | 99/1 | 1086 | +15% |
| 5 | GP2997 | Sancure 2720 | 99/1 | 1136 | +20% |
| 6 | GP2997 | Hauthane L-2020 | 95/5 | 1114 | +18% |
| 7 | Dynea 246 | Hauthane L-2020 | 95/5 | 1231 | +30% |
| 8 | Borden | Hauthane L-2020 | 95/5 | 1217 | +29% |
| | FG486D | | | | |
| 9 | GP2997 | None | 100/0 | 945 | |

It will be apparent to those skilled in the art that variations and modifications of the present invention can be made without departing from the scope or spirit of the invention. For example, embodiments of the fiber mat may be used in a building material including, but not limited to, underlayment, insulation facers, floor and ceiling tile, vehicle parts and or any other suitable building material. Thus, it is intended that the present invention cover all such modifications and variations of the invention, provided they come within the scope of the appended claims and their equivalents.

1. A fiber mat for use in a building material, said mat comprising:
a plurality of fibers;
a resinous fiber binder, said fibers fixedly distributed in said binder; and
a urethane modifier comprising from about 0.1 wt. % to about 50 wt. %, based on the weight of said binder.

2. The fiber mat of claim 1, wherein said urethane modifier comprises a polyurethane modifier.

3. The fiber mat of claim 2, wherein said polyurethane modifier is selected from the group consisting of: an aliphatic polyurethane, an aromatic polyurethane, and a hybrid polyurethane.

4. The fiber mat of claim 1, wherein said fiber binder comprises a formaldehyde type binder.

5. The fiber mat of claim 4, wherein said formaldehyde type binder is selected from the group consisting of: a urea/formaldehyde binder, a phenol/formaldehyde binder, and a melamine/formaldehyde binder.

6. The fiber mat of claim 1, wherein the weight ratio of said fiber binder to said urethane modifier is in the range of from about 200:1 to about 4:1.

7. The fiber mat of claim 1, said mat containing from about 55 wt. % to about 98 wt. % fiber and from about 0.05 wt. % to about 45 wt. % fiber binder.

8. The fiber mat of claim 1, wherein said fibers comprise glass fibers.

9. The fiber mat of claim 1, said mat containing from about 55 wt. % to about 98 wt. % glass fiber and from about 15 wt. % to about 30 wt. % fiber binder.

10. The fiber mat of claim 1, further comprising an asphalt coating on at least one surface of said mat, said mat having a tensile strength greater than about 1,000 psi.

11. A fibrous mat roofing shingle, comprising:
a plurality of glass fibers; and
a fixative composition comprising a fiber binder and between about 0.1 wt. % and about 50 wt. %, based on the weight of said binder, of a polyurethane modifier, wherein said fibers are fixedly distributed in said fixative composition.

12. The fibrous mat of claim 11, wherein the concentration of the fiber binder, based on the weight of the fibrous mat, is in the range of from about 0.05 wt. % and about 45 wt. %.

13. The fibrous mat of claim 11, wherein said glass fibers comprise a plurality of glass filaments having an average length of from about ¼ to about 3 inches and a diameter of from about 1 to about 50 microns.

14. The fibrous mat of claim 11, wherein the concentration of said glass filaments is between about 55 and about 98 wt. %.

15. The fibrous mat of claim 11, wherein said polyurethane modifier is selected from the group consisting of: an aliphatic polyurethane, an aromatic polyurethane, and a hybrid polyurethane.

16. A process of making a fiber mat for use in a building material, said process comprising the steps of:
(a) forming an aqueous fiber slurry;
(b) removing water from the fiber slurry to form a wet fiber mat;
(c) saturating the wet fiber mat with an aqueous solution of a fiber binder and a polyurethane modifier; and
(d) drying and curing the wet fiber mat to form a fiber mat product.

17. The process of claim 16, wherein the weight ratio of the fiber binder to the polyurethane modifier is in the range of from about 200:1 to about 4:1.

18. The process of claim 16, wherein the modifier of step (c) is combined in water with the fiber binder of step (c) to form the aqueous solution.

19. The process of claim 16, further comprising the step of:
(e) coating at least one surface of the fiber mat product with a layer of roofing asphalt,
wherein the fiber mat product has a tensile strength greater than about 1,000 psi.

20. The process of claim 16, wherein the aqueous fiber slurry further comprises a fiber dispersing agent.
